(19) United States
(12) Patent Application Publication
(10) Pub. No.: US 2008/0145918 A1
(43) Pub. Date: Jun. 19, 2008

(54) Method for the Detoxification of a Hazardous Compound

(75) Inventors: Akihiro Hishinuma, Tokyo (JP); Koji Fujita, Tokyo (JP); Koichiro Nakamura, Tokyo (JP); Shinji Kamiya, Tokyo (JP); Takakiyo Tada, Kyoto (JP); Hiroshi Yamauchi, Kanagawa (JP)

Correspondence Address: HAMRE, SCHUMANN, MUELLER & LARSON, P.C., P.O. BOX 2902, MINNEAPOLIS, MN, 55402-0902, US

(73) Assignee: Nippon Sheet Glass Company, Limited, Tokyo (JP)

(21) Appl. No.: 11/794,384

(22) PCT Filed: Dec. 28, 2005
(86) PCT No.: PCT/JP05/24129

§ 371 Date: Sep. 27, 2007

(30) Foreign Application Priority Data
Dec. 28, 2004 (JP) 2004-380435

(51) Int. Cl. A62D 3/02

(52) U.S. Cl. 435/262.5; 588/412

(57) ABSTRACT

It is an object of the present invention to provide a method for the safe and effective detoxification of a hazardous compound containing the arsenic and or the like. The method for the detoxification of a hazardous compound according to the present invention is characterized in that the hazardous compound containing at lest one element selected from the groups comprising arsenic, antimony and selenium is converted to a harmless substance produced by the food chain system.

### BACKGROUND OF THE INVENTION

1. Field of the Invention

The present invention relates to a method for the detoxification of a hazardous compound using the food chain system. In particular, the invention relates to a method for the detoxification of a hazardous compound using an zooplankton. In particular, the invention relates to a method for dealing with an arsenic comprising the step of collecting and detoxifying an arsenic, and accumulating the detoxified arsenic using the food chain system.

2. Related Art Statement

There are the following problems as to the treatment of the arsenic. Therefore, an early development for the effective treatment of the arsenic have been desired:
1. the arsenic is designated as a specified toxic substance by a ground pollution measures law. Actually, methods for cleaning it up by using an absorbent are used. However, as an inorganic arsenic after the absorptive treatment has still high poisonous property, and it is difficult to store, a method for treating and storing safely of an inorganic arsenic has been needed.
2. The art of the control subjects which are used in the water system at the moment is conducted with a filter for the absorptive treatment of the arsenic. In the absorptive treatment, however, there are still problems such as, the shortage of the throughput, insufficiency of the adsorptive treatment from a viewpoint of the material balance. Furthermore, safe measures for store are also needed, and therefore, engineering developments for solving the above problems are urgently needed.
3. An arsenic or arsenious acid comes about as a secondary product in the nonferrous smelting such as a copper concentrate. The arsenic or arsenious acid produced by the nonferrous smelting has been treated as clarificant for a glass in the past. However, such treatments can not be conducted from now on.
4. A sump water spring forth from empty lots in a metalliferous mine is also the same situation as the above mentioned. Such sump water is out of the control subjects. However, there are no solution about an contaminated arsenic in water.
5. Furthermore, in a semiconductor industry which semiconducting crystal of an arsenic containing compound is used, there are still problems that the inorganic arsenic is exposed. Therefore, engineering developments for solving the above problems are urgently needed.

In the meantime, although the inorganic arsenic among arsenic has high poisonous property, it is generally known that as the arsenic are methylated, it become more harmless. The table 1 shows LD₅₀ value of the arsenic in the various sort of the step of the methylation(oral toxicity based on the dosage of drugs which 50% of the used experimental animal died.). As can be clear from table 1, it is recognized that a trimethyl arsenic such as, an arsenocholine, a trimethylarsineoxide, an arsenobetaine, has very low drug toxicity. In particular, LD₅₀ value of the arsenobetaine which is one of the trimethyl arsenic and which is contained in a sea food with large amount, is 10000, and therefore, it is innoxious substance compared to a sugar. Furthermore, a produced arsenobetaine is stable substance, it is not likely to occur demethylation and degradation of the arsenobetaine. It is stable over the long period of time under the ordinary circumstances. The arsenobetaine do not go back to the poisonous demethylated arsenical apecies, if it is not exposed to the decomposition reaction through a certain and specific microorganisms or chemical reaction under the very high temperature.

TABLE 1

| | Chemical species of the arsenic | LD₅₀(mg/kg) |
|---|---|---|
| As(III) | Inorganic arsenic(III(valency)) | 4.5 |
| As(V) | inorganic arsenic(V(valency)) | 14-18 |
| MMA | monomethyl arsonic acid | 1,800 |
| DMA | dimethylarsinic acid | 1,200 |
| AC | arsenocholine | 6,000 |
| TMAO | trimethylarsineoxide | 10,600 |
| AB | arsenobetaine | 10,000 |

In a viewpoint of such knowledge, although it is theoretically possible to methylate the inorganic arsenic with an artificial chemical reaction for the detoxification of the inorganic arsenic, it is practically difficult to carry out it since the existence and administration of intermediate product. Moreover, there are still problems that the method is not safe and needed for a complicated process. FIG. 1 shows a pathway of the methylation of the arsenic, and FIG. 2 shows a structure of the arsenobetaine, respectably.

As mentioned above, although it is possible to collect the inorganic arsenic from the environment using a ferric chloride, cesium hydroxide or chelating agent and or the like, the safe means for the detoxification of the collected inorganic arsenic is poor in the past. Therefore, it is commonly used that the collected inorganic arsenic is deposited on the back-filling plant or disposal field in a mine, or the contaminant part is enclosed with a concrete. Therefore, there are a lot of problems that a large space such as a disposal site is needed, and that harmful inorganic arsenic elute off again. These problems are the same as in a method of collecting and storing an arsenic efficiently concentrated in a narrow space under safe condition.

On the other hand, as a method of treating arsenic using the food chain system, a method for methylating the inorganic arsenic using the model food chain system comprising three steps, that is, chlorella—ceriodaphnia dubia—guppy is researched (Shigeru Maeda, chemical engineering society, annual summary, page 12-13, 1993). In this reference, 82.4% of a total arsenic can be converted to a methylated arsenic(dimethyl arsenic, trimethyl arsenic) in a guppy which the arsenic is finally stored in. In the reference, however, 17.6% of the inorganic arsenic still stayed, which has a high toxicity. According to the method, although it is possible to collect and store the arsenic using the individual organism of the guppy, the methylation for the detoxification of the arsenic is not enough, and therefore, a lot of the inorganic arsenic still stayed, which has a high toxicity. Furtheremore, there are still problems that a fish contains a lot of water in their body, and therefore, it is difficult to dry and not suitable for storing. Moreover, a food chain system comprising chlorella—pond crevettes—rice fish is also came under review. However, it is reported that there are no biological accumulation of the arsenic, and that 20% of the inorganic arsenic still stayed (Takayoshi Kuroiwa et al, Biomed Res Trace Elements 9(3), 1998, p167-168).

Therefore, development of a method for the safe and effective detoxification of the inorganic arsenic, in addition to this, a method for accumulating and storing detoxificated arsenic under the concentrated condition as much as possible have been desired.

The reference 1: Shigeru Maeda, chemical engineering society, annual summary, page 12-13, 1993.

The reference 2: Takayoshi Kuroiwa et al, Biomed Res Trace Elements 9(3), 1998, p167-168)

### SUMMARY OF THE INVENTION

Therefore, it is an object of the present invention to provide a method for the safe and effective detoxification of a hazardous compound containing the arsenic and or the like. Further, in a preferred embodiment, it is an object of the present invention to provide a new method for the safe and effective detoxification of the inorganic arsenic and or the like. Further, it is an object of the present invention to provide a system for treating the arsenic suitable toward industrialization, by producing a method for accumulating and storing the detoxificated arsenic under the concentrated condition as much as possible.

In order to accomplish the above objects, the present inventors made strenuous studies on the effect of the detoxification of the arsenic and or the like in the food chain system, and found that it is possible to convert the hazardous compound containing at lest one element selected from the groups comprising arsenic, antimony and selenium to a harmless substance produced by the food chain system. As a result, the inventors discovered the invention.

The method for the detoxification of a hazardous compound according to the present invention is characterized in that the hazardous compound containing at lest one element selected from the groups comprising arsenic, antimony and selenium is converted to a harmless substance produced by the food chain system.

In a preferred embodiment of the method for the detoxification of a hazardous compound according to the present invention, the method is characterized in that the food chain system comprise an zooplankton.

Further, in a preferred embodiment of the method for the detoxification of a hazardous compound according to the present invention, the method is characterized in that the zooplankton is an artemia.

Further, in a preferred embodiment of the method for the detoxification of a hazardous compound according to the present invention, the method is characterized in that the detoxification is attained by reducing the percentage of the inorganic arsenic existed in the hazardous compound, using the food chain system.

Further, in a preferred embodiment of the method for the detoxification of a hazardous compound according to the present invention, the method is characterized in that the detoxification is attained by increasing the percentage of the organic arsenic existed in the hazardous compound, using the food chain system.

Further, a method of treating the arsenic according to the present invention is characterized in that the method comprises the steps of collecting and detoxificating the arsenic, and accumulating a detoxificated arsenic, and then storing it using the food chain according to any one of claims 1 to 5.

Further, in a preferred embodiment of the method for treating the arsenic according to the present invention, the method is characterized in that the food chain system comprises phytoplankton—zooplankton—shellfish.

Further, in a preferred embodiment of the method for treating the arsenic according to the present invention, the method is characterized in that the shellfish is a shrimp class or a crab class capable of being farmed.

Further, in a preferred embodiment of the method for treating the arsenic according to the present invention, the method is characterized in that the shrimp class is a kuruma prawn(tiger prawn).

Further, in a preferred embodiment of the method for treating the arsenic according to the present invention, the method is characterized in that the phytoplankton is a chlorella, the zooplankton is an artemia, the shellfish is a greasyback shrimp.

Further, in a preferred embodiment of the method for treating the arsenic according to the present invention, the method is characterized in that the shellfish is bred under the existence of a methylating accelerator factor for the arsenic.

Further, in a preferred embodiment of the method for treating the arsenic according to the present invention, the method is characterized in that the artemia is bred under the existence of the methylating accelerator factor for the arsenic.

Further, in a preferred embodiment of the method for treating the arsenic according to the present invention, the method is characterized in that the methylating accelerator factor for the arsenic is a glutathione.

Further, in a preferred embodiment of the method for treating the arsenic according to the present invention, the method is characterized in that the concentration of the inorganic arsenic is reduced to less or equal to a concentration of an inorganic arsenic contained in a sea food of nature, and the inorganic arsenic is converted to a harmless organic arsenic.

In a preferred embodiment of the method of treating the arsenic according to the present invention, the method is characterized in that the method comprises the steps of collecting and detoxificating the arsenic, and accumulating a detoxificated arsenic, and then storing it in safety using the food chain. In a preferred embodiment of the method for treating the arsenic according to the present invention, the concentration of the inorganic arsenic is reduced to less or equal to a concentration of an inorganic arsenic contained in a sea food capable of being taken by human. Further, the present invention can be the method of treating the arsenic using the food chain system comprising phytoplankton—zooplankton—shellfish, which can be industrially available. In the present invention, the shellfish is preferably a shrimp class or a crab class capable of being farmed. Further, in a preferred embodiment of the method for treating the arsenic according to the present invention, the method is characterized in that the phytoplankton is a chlorella, the zooplankton is an artemia, the shellfish is a greasyback shrimp and/or a kuruma prawn(tiger prawn). The present invention is preferably characterized in that the shellfish is bred under the existence of a methylating accelerator factor for the arsenic, in particular, the methylating accelerator factor for the arsenic is preferably a glutathione. Further, the present invention is preferably characterized in that the concentration of the inorganic arsenic is reduced to less or equal to a concentration of an inorganic arsenic contained in a sea food of nature, and the inorganic arsenic is converted to a harmless organic arsenic.

### EFFECT OF INVENTION

According to the invention, a new method for treating arsenic using the food chain system is provided. The invention has an advantageous effect that it gives safer method than that of the methylation according to the chemical reaction. Moreover, according to the invention, it is possible to methylate and render the arsenic harmless in a higher efficiency, and to reduce the amount of the residual inorganic arsenic compared to the above known art using the food chain system comprising guppy(reference 1).

### BRIEF DESCRIPTION OF THE DRAWINGS

For a better understanding of the invention, reference is made to the attached drawings, wherein:

FIG. 1 gives a methylation pathway of the arsenic in mammal class.

FIG. 2 gives a structure of the arsenobetaine.

FIG. 3 gives a graph shows the percentage of the methylated arsenic (an organic arsenic) of the muscle of the greasyback shrimp when the arsenic is treated with a chlorella—an artemia—a greasyback shrimp system.

FIG. 4 gives a graph shows the percentage of the methylated arsenic (an organic arsenic) of the shell of the greasyback shrimp when the arsenic is treated with a chlorella—an artemia—a greasyback shrimp system.

FIG. 5 gives a graph shows the concentration of the trimethylated arsenic (an organic arsenic) of the muscle of the greasyback shrimp when the arsenic is treated with a chlorella—an artemia—a greasyback shrimp system.

FIG. 6 gives a graph shows the concentration of the trimethylated arsenic (an organic arsenic) of the shell of the greasyback shrimp when the arsenic is treated with a chlorella—an artemia—a greasyback shrimp system.

FIG. 7 gives a condition of the metabolism for the inorganic arsenic through the chlorella.

FIG. 8 gives a condition of the metabolism for the inorganic arsenic through the combination of the chlorella and artemia.

FIG. 9 gives a condition of the metabolism for the inorganic arsenic for 14 days after greasyback shrimp is bred.

FIG. 10A gives a residual ratio of the inorganic arsenic (in a part of the muscle of the shrimp) in a chlorella—an artemia—a greasyback shrimp food chain system.

FIG. 10B gives a residual ratio of the inorganic arsenic (in a part of the muscle of the shrimp) in a chlorella—an artemia—a greasyback shrimp food chain system. FIG. 10B gives an enlarged illustration of the FIG. 10A.

FIG. 11A gives a residual ratio of the inorganic arsenic (in a part of the shell of the shrimp) in a chlorella—an artemia—a greasyback shrimp food chain system.

FIG. 11A gives a residual ratio of the inorganic arsenic (in a part of the shell of the shrimp) in a chlorella—an artemia—a greasyback shrimp food chain system. FIG. 11B gives an enlarged illustration of the FIG. 11A.

FIG. 12 gives a percentage of the methylated arsenic among all arsenic in the muscle of the kuruma prawn in a chlorella—an artemia—a greasyback shrimp food chain system.

FIG. 13 gives a residual ratio of the inorganic arsenic in the muscle of the kuruma prawn in the food chain system comprising a chlorella—an artemia—a kuruma prawn.

FIG. 14 gives an concentration effect of the trimethylated arsenic in the muscle of kuruma prawn.

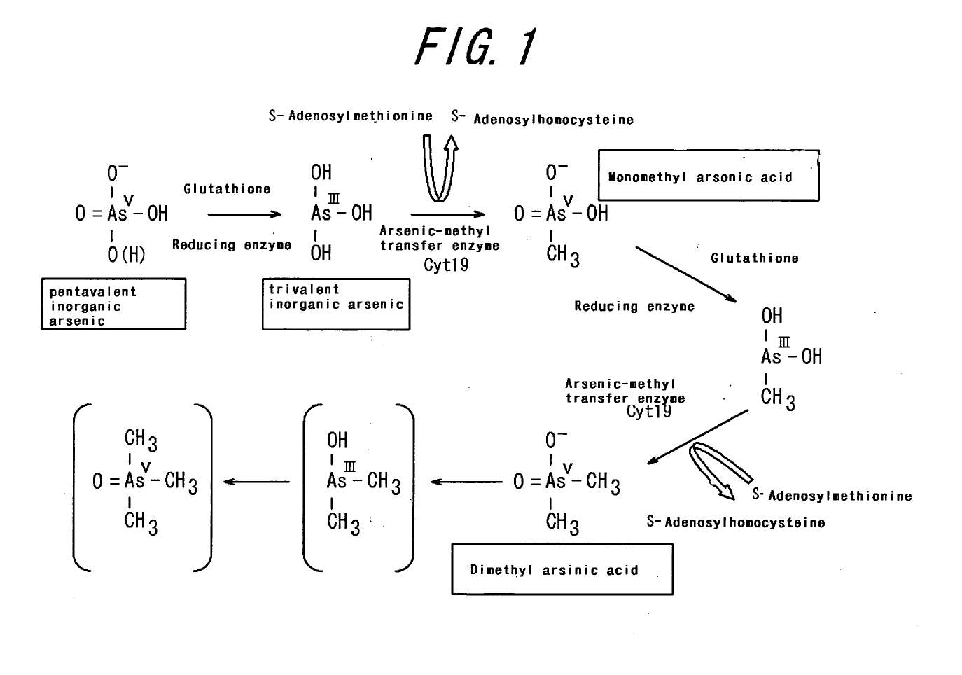

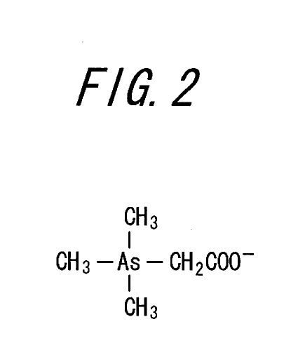

The method for the detoxification of a hazardous compound according to the present invention is characterized in that the hazardous compound containing at lest one element selected from the groups comprising arsenic, antimony and selenium is converted to a harmless substance produced by the food chain system. The term “the hazardous compound” used herein means a compound which gives any adverse affect to the organism when it is exposed to the organism in the environment.

As a hazardous compound containing the arsenic among the hazardous compound, mention may be made of arsenious acid, arsenic pentoxide, arsenic trichloride, arsenic pentachloride, arsenic sulfide compound, cyano arsenic compound, chloro arsenic compound, and other arsenic inorganic salt and or the like. In these arsenic, for example, LD₅₀(50% of the fatal dose in mouse) is less or equal to 20, and therefore, it is generally a poisonous value for the organism.

Further, as a hazardous compound containing antimony, mention may be made of antimony trioxide, antimony pentoxide, antimony trichloride, and antimony pentachloride and or the like.

Furthermore, as a hazardous compound containing selenium, mention may be made of selenium dioxide, selenium trioxide and or the like.

In a preferred embodiment of the present method, the food chain system comprises an zooplankton. According to such an zooplankton, it is possible to convert the hazardous compound to a more harmless substance by using such an zooplankton. Such an zooplankton is preferably an artemia from view points that it is possible to effectively convert the hazardous inorganic substance to a more harmless organic substance.

In a preferred embodiment of the present invention, it is possible to convert the hazardous compound to a more harmless substance by reducing the ratio of the inorganic arsenic existed in the hazardous compound through the food chain system as mentioned above. Furthermore, the present invention is characterized in that the detoxification is attained by increasing the percentage of the organic arsenic existed in the hazardous compound, using the food chain system. As mentioned above table 1, the LD₅₀ value of the organic arsenic is lager than the inorganic arsenic, and in particular, it is recognized that the organic arsenic, for example, trimethylarsineoxide, arsenobetaine, and or the like are more harmless than sugar etc. In the present invention, it is possible to convert the inorganic arsenic to a more stable and harmless organic arsenic.

Next, a method for treating the arsenic according to the present invention will be described in detail below. That is, the present invention is characterized in that the method comprises the steps of collecting and detoxificating the arsenic, and accumulating a detoxificated arsenic, and then storing it using the food chain as mentioned above. That is, the use of the above zooplankton make it possible to convert the hazardous compound to the harmless substance. In addition to this, the harmless substance is itself very stable substance in nature. Therefore, it is possible to stably store from a viewpoint that the obtained harmless substance, for example, the arsenobetaine do not go back to the start substance, that is, the hazardous compound by instantly occurring the reverse reaction under the in usual condition.

Further, in a preferred embodiment of the method for treating the arsenic according to the present invention, the food chain system comprising phytoplankton—zooplankton—shellfish is used. This is reasons that the use of the shellfish may be exemplified from a viewpoint of a further stable storage although it is adequately possible to detoxificate the hazardous compound using the above zooplankton.

As the shellfish, mention may be made of a shrimp class or a crab class capable of being farmed.

Further, in a preferred embodiment of the method for treating the arsenic according to the present invention, the method is characterized in that the phytoplankton is a chlorella, the zooplankton is an artemia, the shellfish is a greasyback shrimp.

Moreover, the effect which the present invention aims, may also be attained by using the food chain system comprising phytoplankton—zooplankton—shellfish and or the like, ant it is not limited to the use of the food chain system comprising the chlorella—the artemia—the greasyback shrimp.

At this moment, the term “the food chain system comprising phytoplankton—zooplankton—shellfish” used herein means a food chain system comprising the steps of being taken up the arsenic by the phytoplankton, and allowing the zooplankton to consume the phytoplankton containing the taken up arsenic, and further allowing the shellfish to consume the zooplankton containing said phytoplankton. In a similar way, the term “the food chain system comprising the chlorella—the artemia—the greasyback shrimp” used herein means a food chain system comprising the steps of being taken up the arsenic by the chlorella, and allowing the artemia to consume the chlorella containing the taken up arsenic, and further allowing the greasyback shrimp to consume the artemia containing said chlorella. And further, the term “less or equal to a concentration of an inorganic arsenic contained in a sea food of nature” means less or equal to a concentration of an inorganic arsenic naturally contained in a sea food under the circumstance with no contamination caused by the arsenic. That is, according to the present invention, it is possible to reduce the concentration of the inorganic arsenic to less or equal to that contained in the sea food of nature in a final stage of the food chain system.

Moreover, in the above food chain system, the chlorella (Chlorella regularis, green algae, classification of chlorella) aims at the collection and methylation of the inorganic arsenic from seawater, artemia (Artemia saline, Crustacea, classification of Anostraca) aims at accelerating of the further methylation of the arsenic. Further, greasyback shrimp(Metapenaeus ensis, Decapoda, classification of Penaeidae) play a role in accumulating and concentrating the detoxificated and methylated arsenic in their body, and making it easy to collect the individual organism imported the methylated arsenic from the seawater through the ingestion of containing the arsenic. Moreover, the chlorella and artemia is a representative phytoplankton and zooplankton, respectively, which are generally and well used as an industrial bait of the sea farming.

The use of the shrimp at the end of the food chain has an advantage that the muscle of the shrimp can be separated from the shell of the shrimp. Since the amount of the accumulated and trimethylated arsenic in the shell of the shrimp is higher than in their body, the use of the shrimp is suitable for making it easy to dry and store compared to the other fish which has no shell, and therefore, makes it difficult to separate the muscle from the skin. Therefore, it is possible to produce a system for industrially and more effectively treating the arsenic in a complete closure system, according to the selection of a system of treating the arsenic using the food chain system, wherein the shrimp which makes it easy to collect and treat, is used in the final step of the food chain.

Moreover, as the phytoplankton used in the first step according to the present invention, mention may be made of chlorella, marine plants, and porphyra yezoensis, but it is not limited. The other phytoplankton may be used as long as it attains the effect of the collection and methylation of the arsenic. Since the chlorella used in the following examples is, in general, commercially available and suitable for the mass production, in particular, the use of the chlorella in the present invention is preferable embodiment. The phytoplankton used in the present invention may be, however, a phytoplankton other than the chlorella as long as is has an effect that it can absorb the inorganic arsenic contained in the solution in a short period of time. Furthermore, the organism used in the first step is not necessarily limited to the phytoplankton, it is possible to use the other organism as long as it may collect the arsenic and it is an object for the ingestion of the organism in the next step.

Furthermore, as the zooplankton used in the second step according to the present invention, mention may be made of artemia, copepoda, arrowworm, and rotifers, but it is not limited. The other zooplankton may be used as long as it attains the effect of the methylation and detoxification of the arsenic. That is, the zooplankton used in the present invention may be those capable of accelerating the methylation of the arsenic with no increase of the amount of the inorganic arsenic contained in the organism of the previous step. In particular, the use of the artemia in the following example is preferable embodiment. The artemia is the marine zooplankton which has 0.5 to 1.0 mm of the full length, and is known as a sea monkey. The artemia is used as a bait for a fish and shellfish immediately after the hatch in cultural fishery. Moreover, the organism used in the second step is not necessarily limited to the zooplankton, it is possible to use the other organism as long as it may be an object for the ingestion of the organism in the next third step.

Furthermore, as the shellfish used in the second step according to the present invention, mention may be made of the shrimp and crab class, such as the greasyback shrimp and kuruma prawn(tiger prawn), it is not limited to those. Moreover, the term “a shrimp class or a crab class capable of being farmed” broadly includes a various sort of the shrimp class or the crab class which is generally farmed for the application for food etc. The other shellfish or clam class, such as moule and giant pacific oyster may be used as long as it can attain the effect that these can collect the detoxificated arsenic. The final organism of the food chain system used in the present invention may be those capable of concentrating the arsenic and stably accumulating and storing it. In particular, the use of the shrimp capable of being farmed such as the greasyback shrimp and kuruma prawn(tiger prawn) in the following example is preferable embodiment. The greasyback shrimp is from the southern regions, and has 5 to 10 cm of the full length, and is distributed in the Pacific Ocean coastline to the south of the Bay of Tokyo, and in the Sea of Japan to the south of the Bay of Toyama.

It is possible to further accelerate the accumulation and concentration of the trimethylarsenic by breeding the greasyback shrimp under the existence of the methylating accelerator factor for the arsenic, such as a reduced glutathione(GSH). Therefore, a higher effect may be attained in the present invention by breeding the greasyback shrimp under the condition including the methylating accelerator factor. As the methylating accelerator factor of the arsenic, mention may be made of GSH, betaine, or methionine, but it is not limited to those. It is thought that the conversion to the arsenobetaine may be accelerated by adding those substances, although it is thought that a reducing ability for the arsenic or the transmethylation reaction are likely to be a rate controlling in the conversion to the arsenobetaine. Therefore, the use of the methylating accelerator factor such as GSH and or the like produces a industry system of treating arsenic capable of accumulating and storing trimethylated arsenic into the greasyback shrimp under the further concentrated condition.

### EXAMPLE

The present invention will be concretely explained in more detail with reference to Examples, but the invention is not intended to be interpreted as being limited to Examples.

### Example 1

An accumulation examination and content test of the arsenic concerning the chlorella, the artemia and the greasyback shrimp was carried out as follows.

### (1) An Accumulation Examination of the Arsenic Concerning the Chlorella

An accumulation of the arsenic was carried out by culturing the chlorella (Chlorella regularis, Nippon Chlorella) using a culture apparatus(5 L culture bath). A sodium arsenite(trivalent inorganic arsenic) was added into the culture medium so that the concentration of the sodium arsenite could be 1 ppm, and then the accumulation examination of the arsenic was carried out for three days by culturing the chlorella under illumination, 25° C., and 1 L/minute of the air flow. After culture, the algal cells of the chlorellas were harvested by using the centrifugation, thereby obtaining about 50 g of the chlorella by a wet weight.

### (2) An Accumulation Examination of the Arsenic Concerning the Artemia

1 g of a marine-derived plankton, artemias(Artemia salina, Tetra Co., Ltd.) were bred by supplying 1 g of chlorella including the above sodium arsenite as a bait. A breeding period of the artemia was for 1 day. The artemias were bred in a glass bath containing 2 L of an artificial seawater(Highpet) at 25° C. After breeding, the artemias were collected by the centrifugation.

### (3) An Accumulation Examination of the Arsenic Concerning the Greasyback Shrimp

The greasyback shrimps(Metapenaeus ensis) were bred by supping the artemia as a bait, in the water bath(30 cm×30 cm×30 cm) using 20 L of an artificial seawater(Highpet). The greasyback shrimps were categorized by three group when it was provided for the breeding. First group was bred under the condition of the only artificial seawater, and another group was bred under the condition of the artificial seawater with the addition of 1 mM of glutathione(Nacalai Tesque, INC.), and the other group was bred under the condition of the artificial seawater with the addition of 10 mM of glutathione. the artemias (1 g per 1 times of feeding) were fed for every three days. A breeding period of the greasyback shrimp was for 28 days.

### (4) A Content Test of the Arsenic

After the accumulation test, the inorganic arsenic and organic arsenic existed in the organism concerning the chlorella, the artemia and the greasyback shrimp was examined. The content test of the inorganic arsenic and organic arsenic was carried out by using an arsenic analysis system for the various sort of the appearance(Shimadzu Corporation, atomic absorption spectro photometer AA-6800, pretreatment system ASA-2sp). Moreover, the content of the arsenic was examined by a wet weight in the content test, but it was converted to a dry weight by carrying out the another following test.

That is, the concentration of the wet weight was converted to the concentration of the dry weight by estimating a weight before and after heating each biological sample at 110° C. for 6 hours, and thereby obtaining a rate of hydrate. Thus estimated value of water content was 76% in the shell of the greasyback shrimp and 75% in the muscle(flesh) of the greasyback shrimp, respectively. Moreover, when water content was calculated about the chlorella, and artemia, 94% was for the artemia, 84% was for the chlorella. The conversion of the concentration of the dry weight was carried out by using water content concerning the shell and muscle of shrimp thus obtained according to the following formula:

The concentration of the dry weight(μ gAs/g dry)=The concentration of the wet weight(μ gAs/g wet)/((1-rate of hydrate)/100)

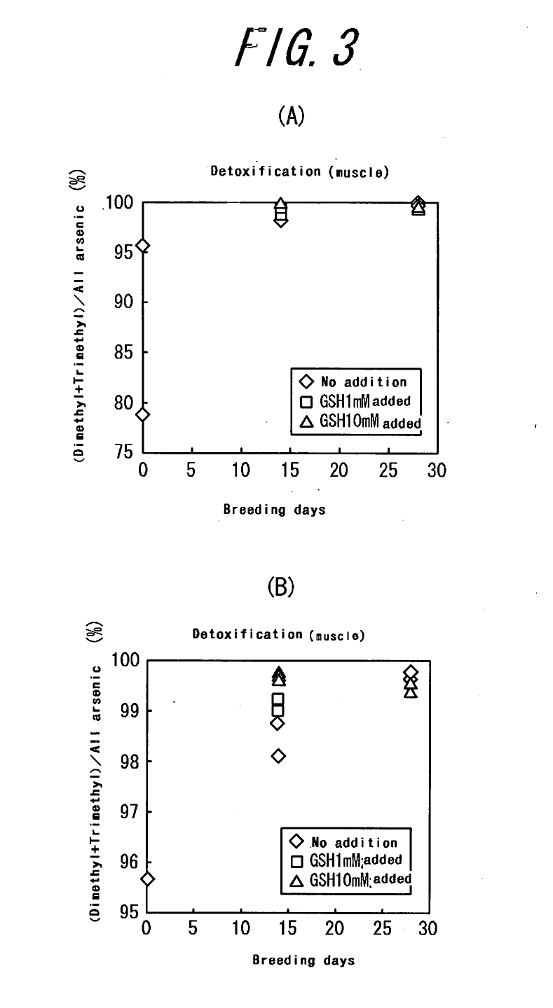

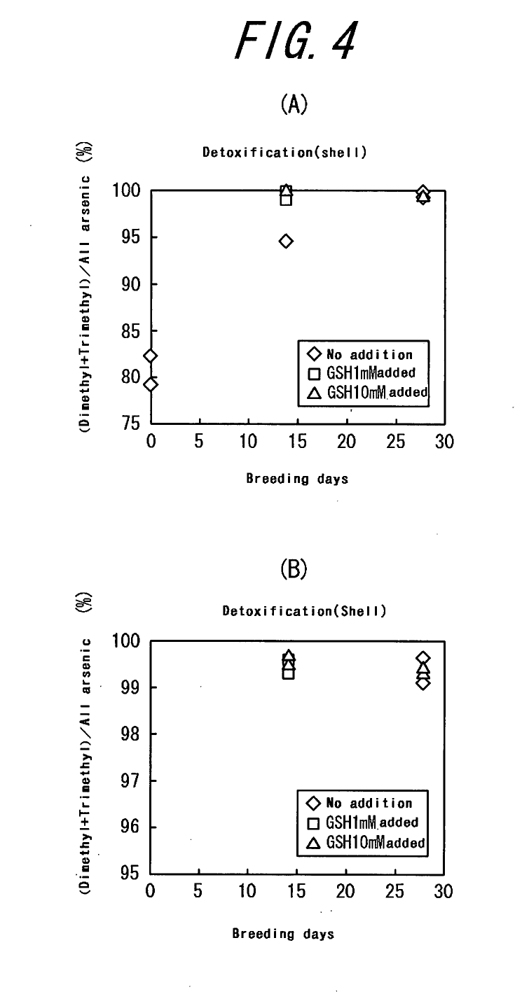

A rate of the methylated arsenic(trimethyl and dimethyl) in the all arsenic(methylated arsenic(trimethyl and dimethyl)/all arsenic(%)) in the food chain system comprising the chlorella, the artemia and the greasyback shrimp, was measured. And it was compared with the result of the food chain system comprising chlorella—water flea—guppy as a comparative example. FIG. 3 shows data of the detoxification in the muscle, and FIG. 4 shows data of the detoxification in the shell, respectively. The rhomboid-shaped mark shows no addition of GSH, the tetragonal mark shows addition of 1 mM of GSH, the triangular mark shows addition of 10 mM of GSH, respectively. Moreover, FIG. 3(B) gives an enlarged illustration of the FIG. 3(A), and FIG. 4(B) gives an enlarged illustration of the FIG. 4(A).

FIGS. 3 and 4 showed that the methylation of the arsenic with the age was recognized in both muscle and shell in the system comprising the chlorella, the artemia and the greasyback shrimp. Furthermore, the rate of the methylated arsenic was higher than that of the comparative example(82.4% of total with 1.2% of the dimethylated arsenic, 81.2% of the trimethylated arsenic, see reference 1). Further, the rate of methylated arsenic might bed rapidly increased by adding the GSH.

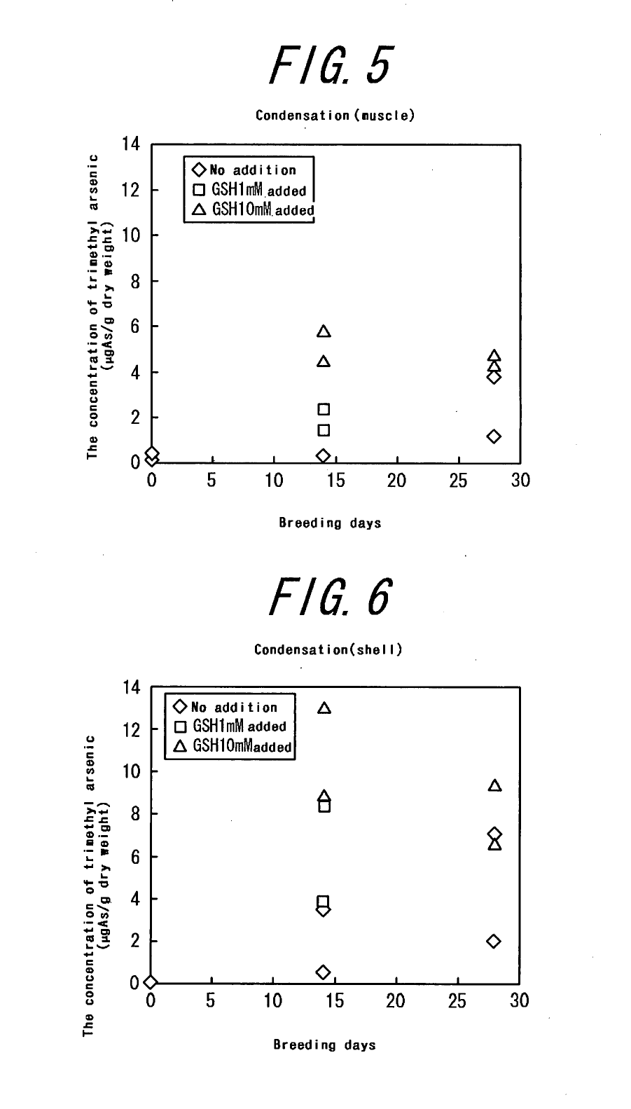

Furthermore, a concentration effect of the trimethylated arsenic was confirmed by measuring the concentration of the trimethlated arsenic in the muscle and shell of the greasyback shrimp. FIG. 5 shows data of the detoxification in the muscle, and FIG. 6 shows data of the detoxification in the shell, respectively. The rhomboid-shaped mark shows no addition of GSH, tetragonal mark shows addition of 1 mM of GSH, triangular mark shows addition of 10 mM of GSH, respectively. FIGS. 5 and 6 showed the concentration of the arsenic with the age was recognized in both muscle and shell in the system comprising the chlorella, the artemia and the greasyback shrimp. Furthermore, the concentration of the trimethylated arsenic was accelerated by the addition of the glutathione. Moreover, the concentration of the trimethylated arsenic in the comparative example(reference 1) was 6.9(μ g As/g dry). In particular, a condensation effect of the arsenic could be obtained in the shell compared with the comparative example.

### Example 2

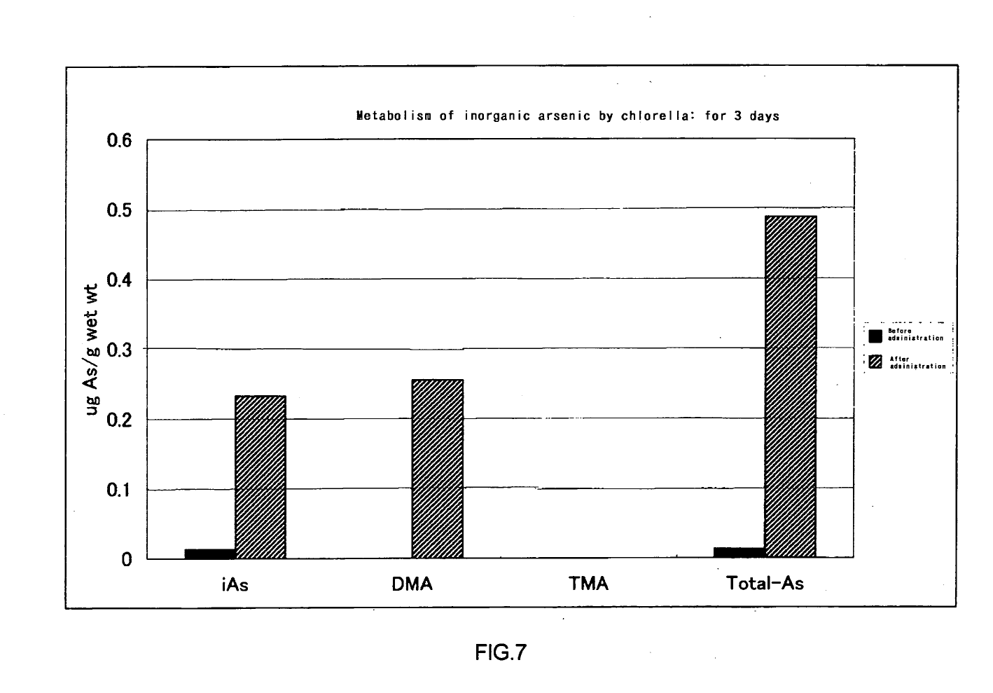

Next, a condition of the metabolism for the inorganic arsenic through the chlorella described in the example 1 was examined. A condition for the accumulation of the arsenic of the chlorellas was the same as the example 1. The period of time for the accumulation was 3 days. FIG. 7 gives a rate of the inorganic arsenic, the dimethylated arsenic(DMA), and the trimethylated arsenic(TMA) before and after the administration of the sodium arsenite. As can be seen from the result of FIG. 7, it is recognized that the harmful inorganic arsenic can be methylated to more harmless organic arsenic(dimethylated arsenic) by the only use of chlorella.

Further, an investigation as to the detoxification of the hazardous compound was carried out by using the zooplankton. In the case that the artemia was used as the zooplankton, the effect thereof was also examined.

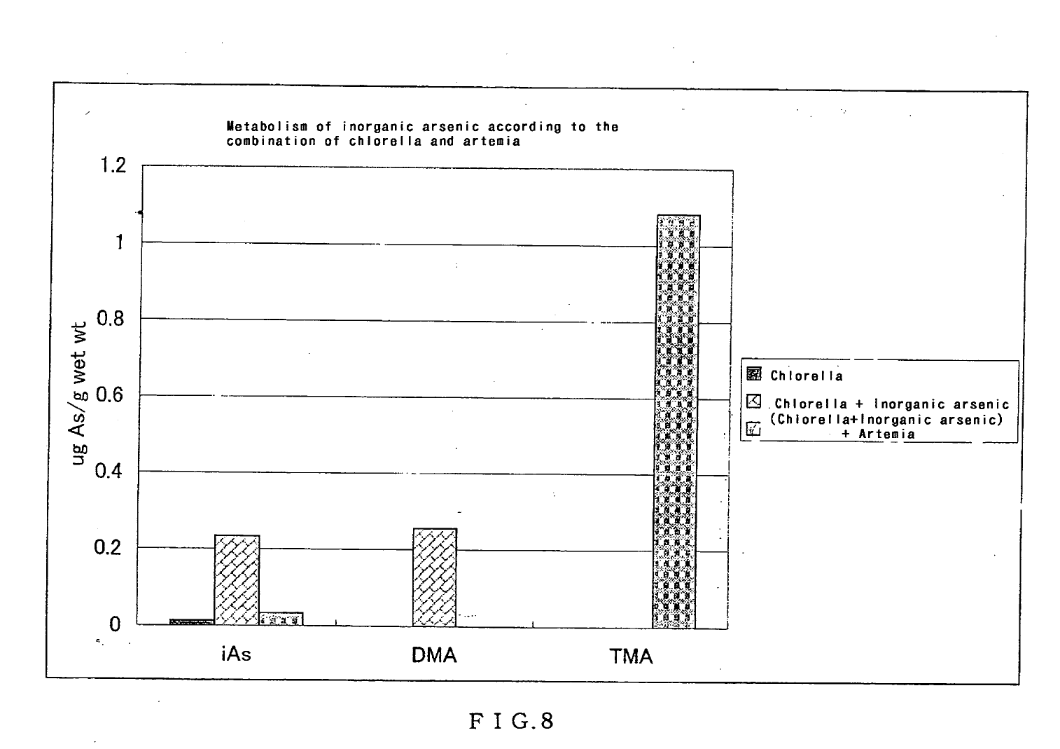

FIG. 8 shows a condition of the metabolism for the inorganic arsenic through the combination of the chlorella and artemia. According to this, it is recognized that the artemia allows most of the inorganic arsenic and dimethylated arsenic to be converted into more stable organic arsenic(trimethylated arsenic) through the methylation. That is, as can be seen from this FIG. 8, it is recognized that the zooplankton such as the artemia allows to induce the metabolism of the inorganic arsenic and dimethylated arsenic to trimethylated arsenic further methylated. That is, it is recognized that it is possible to induce the metabolism of the inorganic arsenic and dimethylated arsenic to more stable trimethylated arsenic by the use of the zooplankton such as the artemia. Therefore, it was suggested that the zooplankton plays an important role in the detoxification.

### Example 3

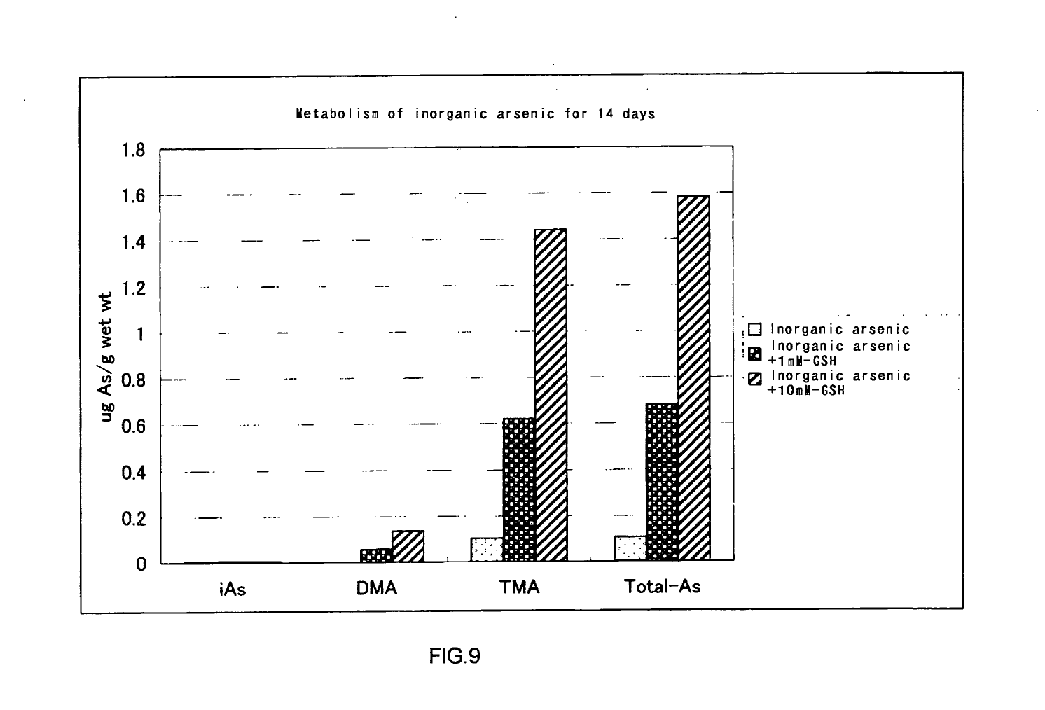

Next, the effect concerning the metabolism of the inorganic arsenic according to the food chain system described in the example in the case of the use of the methylating accelerator factor, was examined. The test conditions etc. are the same as the example 1. The reduced glutathione(GSH) was used as the methylating accelerator factor. The result of this is shown in FIG. 9. FIG. 9 shows a condition of the metabolism for the inorganic arsenic for 14 days after greasyback shrimps were bred. According to this, both in the case of the use of 1 mM-GSH and in the case of the use of 10 mM-GSH, it was shown an excellent result that it was possible to convert more a lot of the inorganic arsenic to the dimethylated arsenic or trimethylated arsenic. On the other hand, there are no inorganic arsenic, and therefore, it is found that it is possible to reduce the amount of the inorganic arsenic, and increase the amount of the organic arsenic, thereby converting the hazardous compound to more harmless substance.

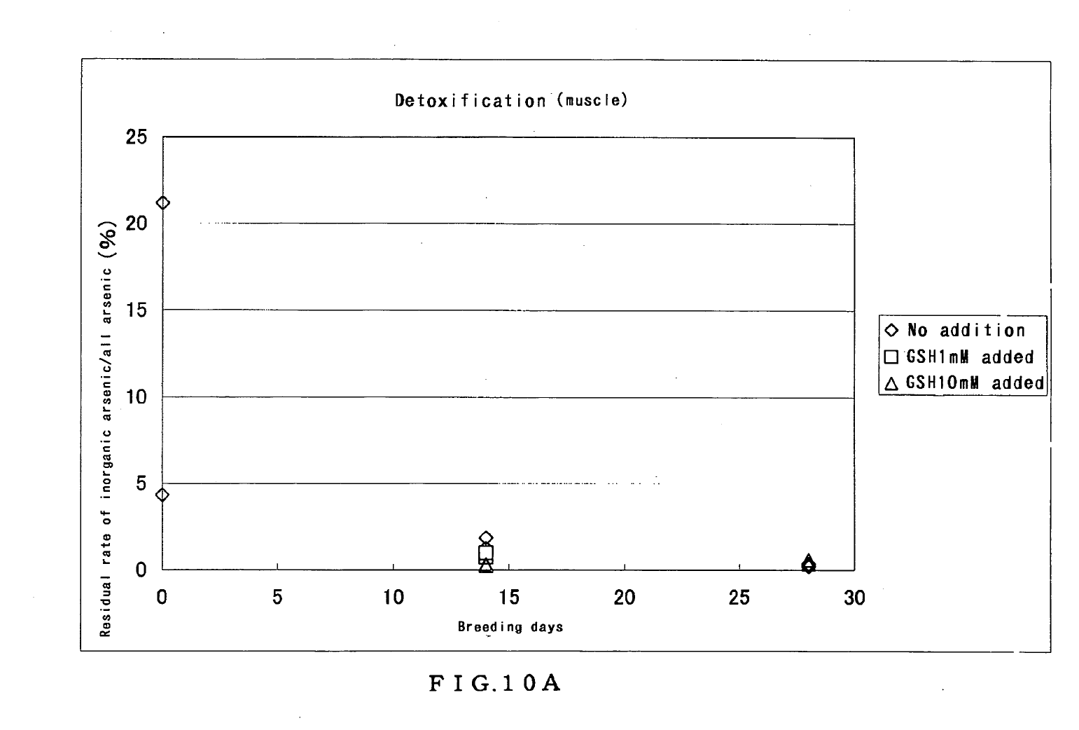

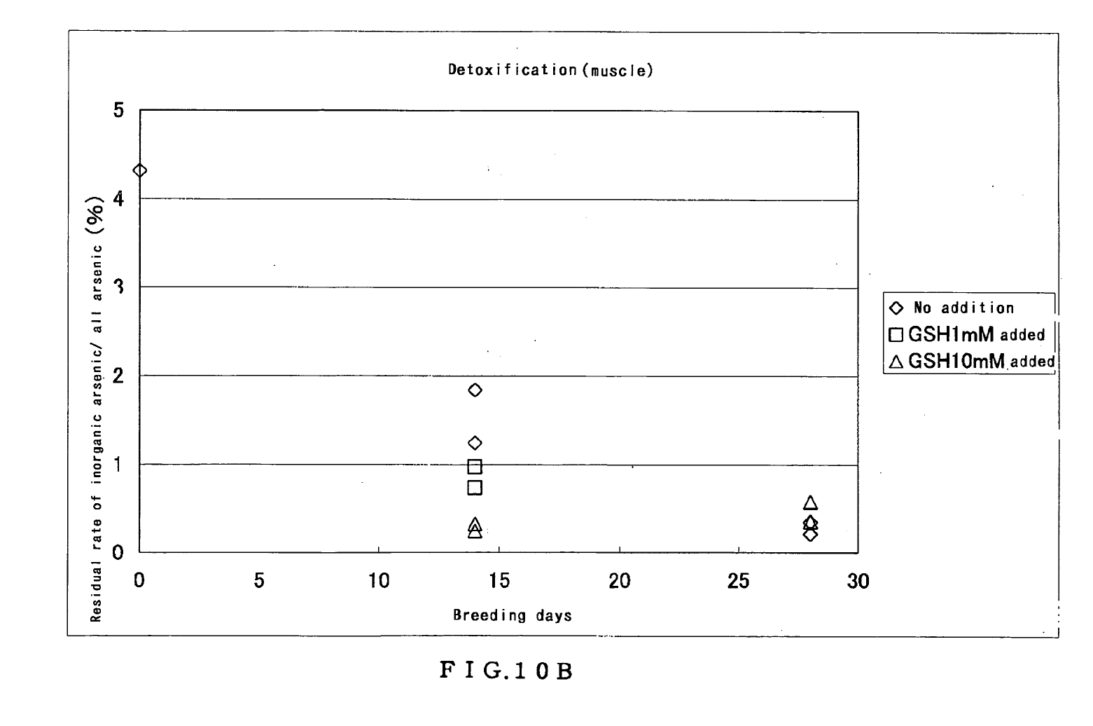

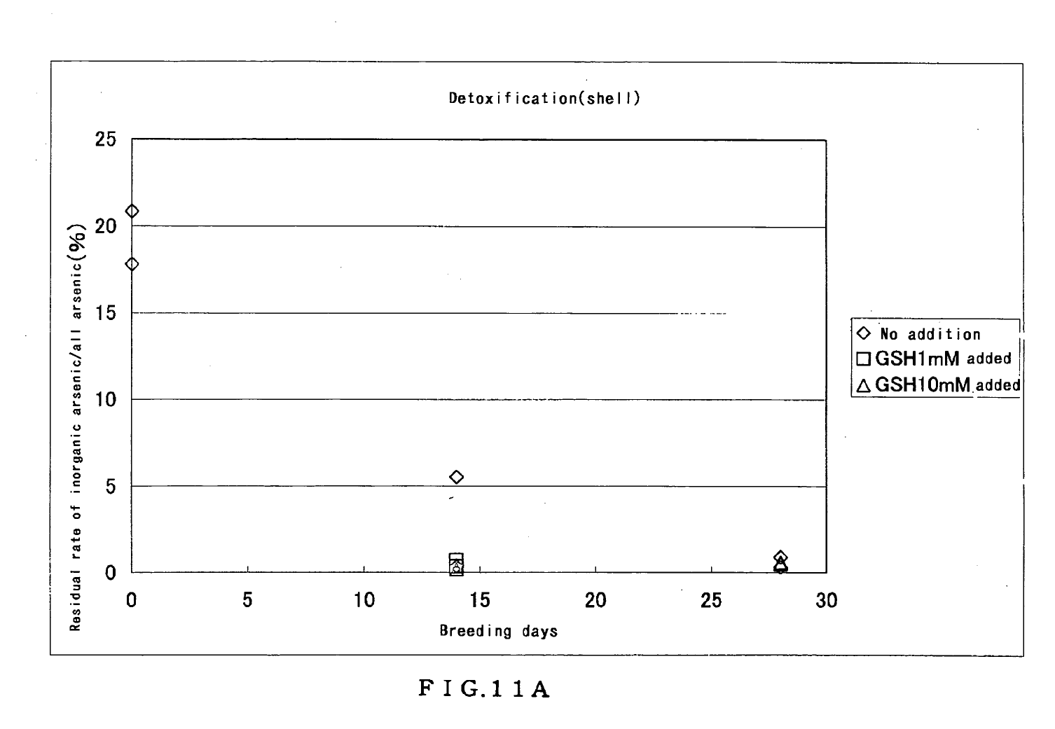

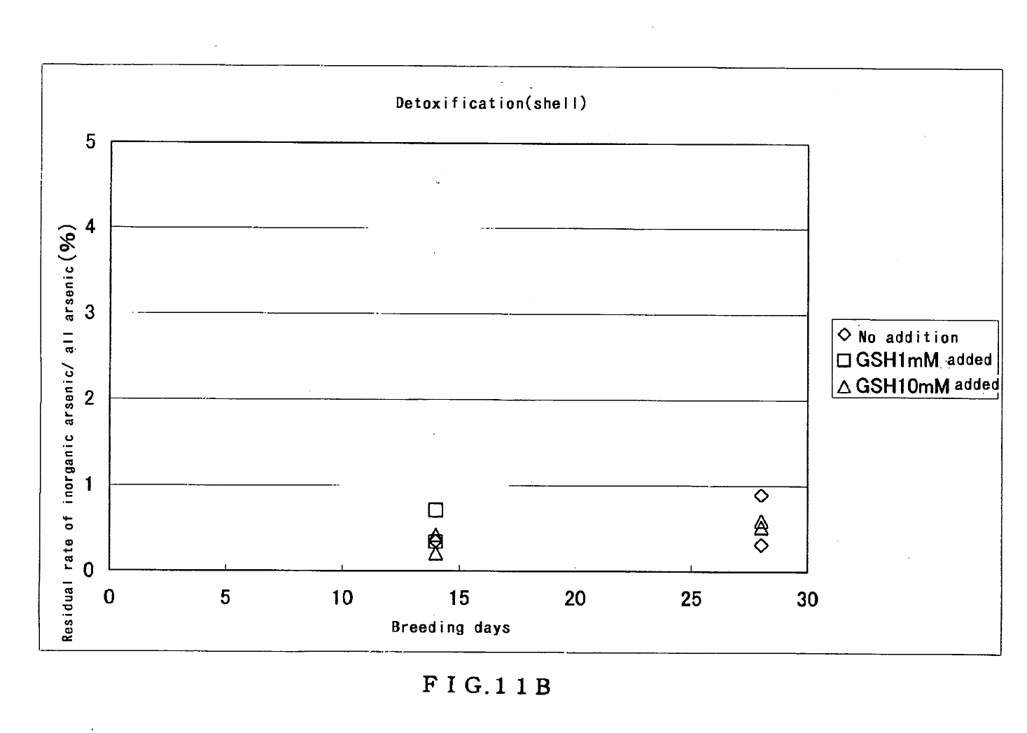

Furthermore, the residual volume of the inorganic arsenic existed in the shrimp was also examined. The result is shown in FIGS. 10 and 11. FIG. 10 shows a residual ratio of the inorganic arsenic (in a part of the muscle of the shrimp) in a chlorella—an artemia—a greasyback shrimp food chain system. FIG. 10(B) gives an enlarged illustration of the FIG. 10(A).

FIG. 11 shows a residual ratio of the inorganic arsenic (in a part of the shell of the shrimp) in a chlorella—an artemia—a greasyback shrimp food chain system. FIG. 11(B) gives an enlarged illustration of the FIG. 11(A). As a result, it is recognized that the residual ratio of the inorganic arsenic successfully reduces as days pass in both the muscle and shell part of the shrimp. That is, the inventors succeed in reducing the residual ratio of the inorganic arsenic which is generally regarded as harmful as long as possible.

### Example 4

An accumulation examination and content test of the arsenic concerning the chlorella, the artemia and the kuruma prawn was carried out as follows.

### (1) An Accumulation Examination of the Arsenic Concerning the Chlorella

An accumulation of the arsenic was carried out by culturing the chlorella (Chlorella regularis, Nippon Chlorella) using a culture apparatus(5 L culture bath). A sodium arsenite(trivalent inorganic arsenic) was added into the culture medium so that the concentration of the sodium arsenite could be 1 ppm, and then the accumulation examination of the arsenic was carried out for three days by culturing the chlorella under illumination, 25° C., and 1 L/minute of the air flow. After culture, the algal cells of the chlorellas were harvested by using the centrifugation, thereby obtaining about 50 g of the chlorella by a wet weight.

### (2) An Accumulation Examination of the Arsenic Concerning the Artemia

A marine-derived plankton, artemias(Artemia salina, Tetra Co., Ltd.) were bred every 1 g by supplying 1 g of chlorella including the above sodium arsenite as a bait. The artemias were categorized by two groups, the concentration of 0.1 mM of the glutathione(Sigma) was added to one group. A breeding period of the artemia was for 1 day. The artemias were bred in a glass bath containing. 2 L of an artificial seawater(Highpet) at 25° C. After breeding, the artemias were collected by the centrifugation.

### (3) An Accumulation Examination of the Arsenic Concerning the Kuruma Prawn

The kuruma prawns were bred by supplying the artemia as a bait, in the water bath(30 cm×30 cm×30 cm) using 20 L of an artificial seawater(Highpet). The kuruma prawns were categorized by two groups when it was provided for the breeding. The first group was bred under the condition of the existence of both the artificial seawater and the glutathione by supplying the artemia as a bait(1 g per 1 times of feeding) for every 3 days, and another group was bred under the condition of the only artificial seawater by supplying the artemia as a bait(1 g per 1 times of feeding) for every 3 days, respectively. A breeding period of the kuruma prawn was for 7 and 14 days.

### (4) A Content Test of the Arsenic

After the accumulation test, the inorganic arsenic and organic arsenic existed in the organism concerning the chlorella, the artemia and the kuruma prawn was examined. The content test of the inorganic arsenic and organic arsenic was carried out by using an arsenic analysis system for the various sort of the appearance(Shimadzu Corporation, atomic absorption spectro photometer AA-6800, pretreatment system ASA-2sp). Moreover, the content of the arsenic was examined by a wet weight in the content test, but it was converted to a dry weight by carrying out the another following experiment.

That is, the concentration of the wet weight was converted to the concentration of the dry weight by estimating a weight before and after heating each biological sample at 110° C. for 6 hours, and thereby obtaining a rate of hydrate. Thus estimated value of water content was 75% in the muscle of the kuruma prawn. Moreover, when water content was calculated about the chlorella and artemia, 94% was for the artemia, 84% was for the chlorella. The conversion of the concentration of the dry weight was carried out by using water content concerning the muscle and shell of kuruma prawn thus obtained according to the following formula:

The concentration of the dry weight(μ gAs/g dry)=The concentration of the wet weight(μ gAs/g wet)/((1-rate of hydrate)/100)

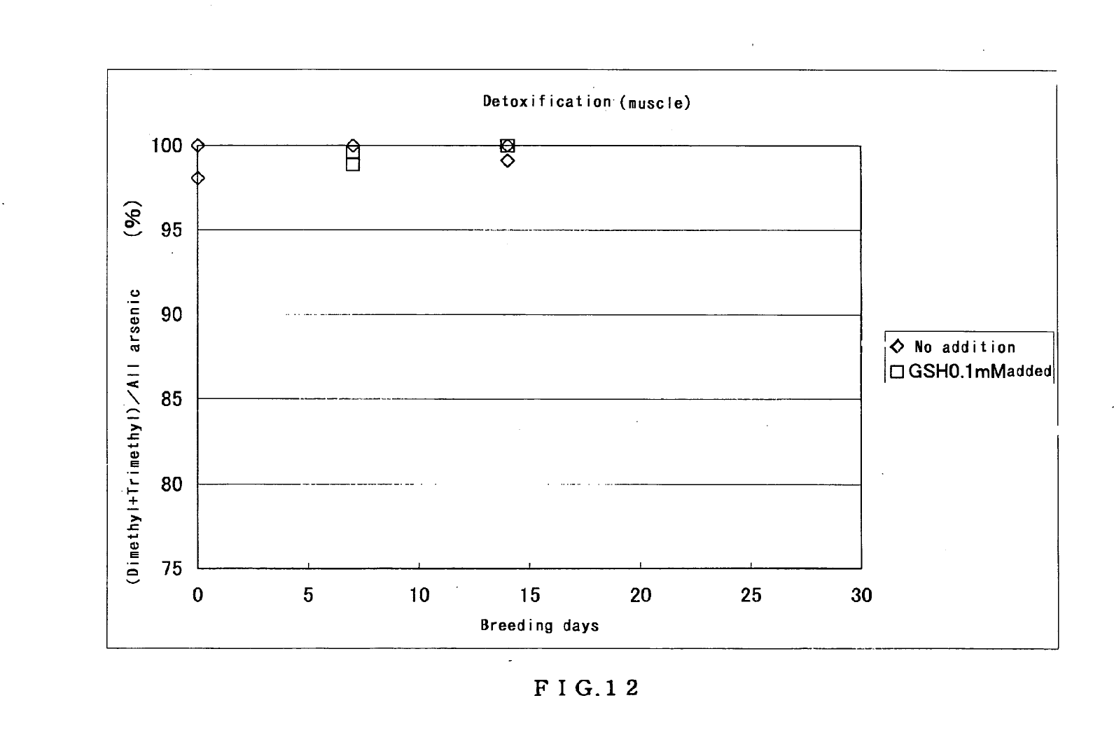

A rate of the methylated arsenic(trimethyl and dimethyl) in all the arsenic(methylated arsenic(trimethyl and dimethyl)/all arsenic(%)) in the food chain system comprising the chlorella, the artemia and the kuruma prawn, was measured, and the result was shown in FIG. 12. And it was compared with the result of the food chain system comprising chlorella—water flea—guppy as a comparative example. In FIG. 12, the rhomboid-shaped mark shows no addition of GSH, the tetragonal mark shows addition of 1 mM of GSH, the triangular mark shows addition of 10 mM of GSH, respectively.

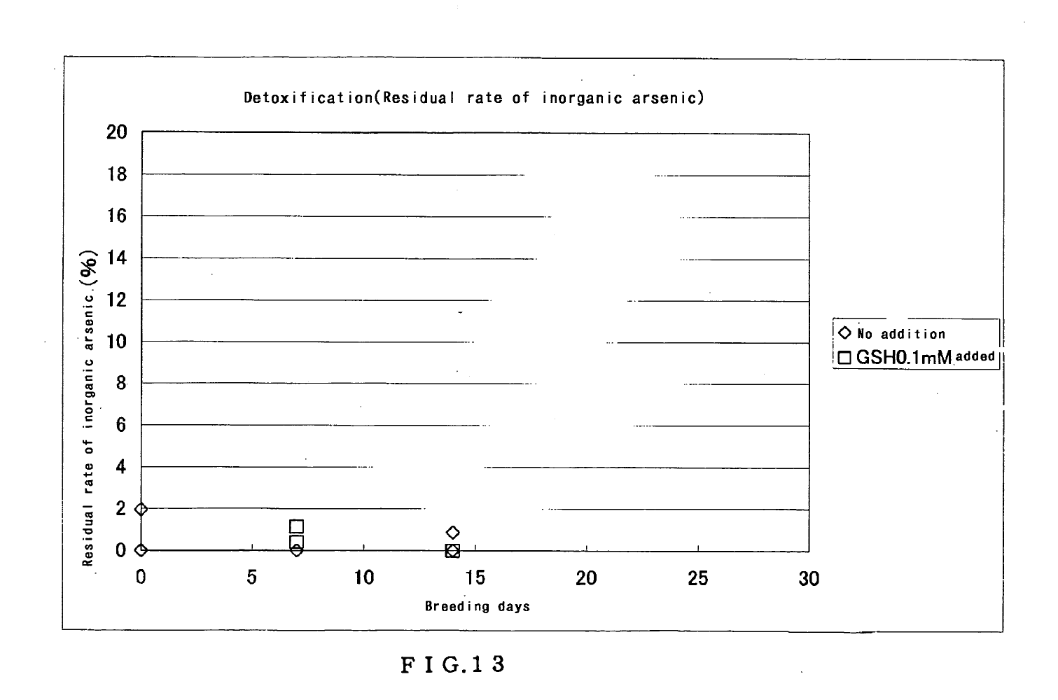

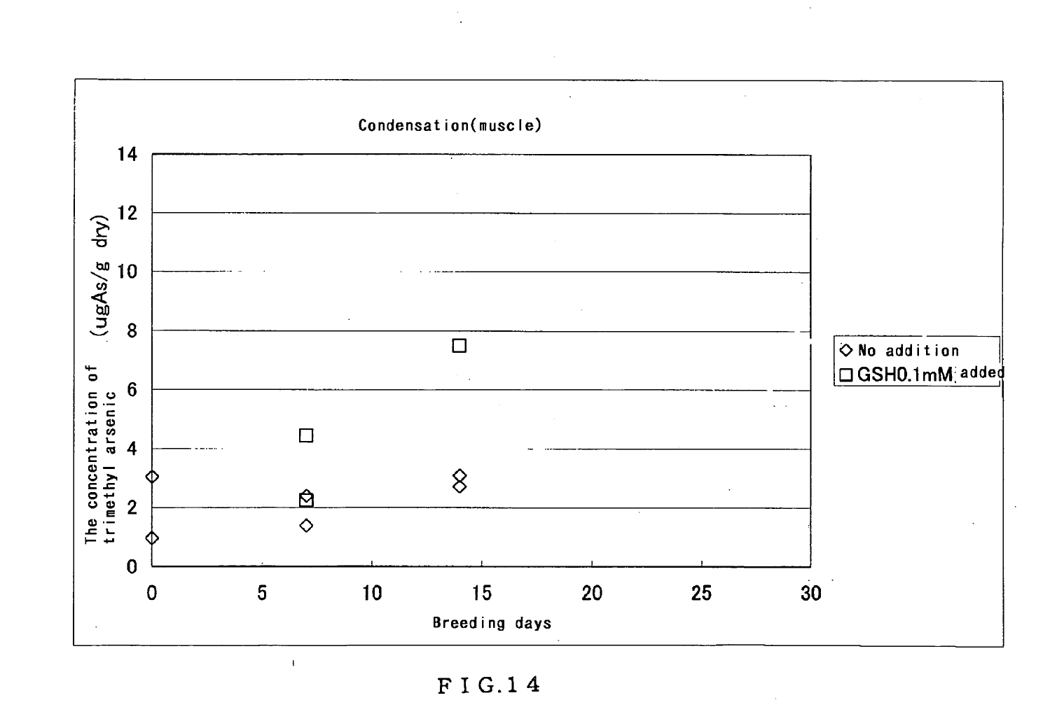

Furthermore, the residual volume of the inorganic arsenic existed in the kuruma prawn was also examined. The FIG. 13 gives a residual ratio of the inorganic arsenic in the food chain system comprising a chlorella—an artemia—a kuruma prawn. In FIG. 13, the rhomboid-shaped mark shows no addition of GSH, the tetragonal mark shows addition of 1 mM of GSH, respectively. Further, a concentration effect of the trimethylated arsenic was confirmed by measuring the concentration of the trimethylated arsenic in the muscle of the kuruma prawn. Moreover, the result was shown in FIG. 14. In FIG. 14, the rhomboid-shaped mark shows no addition of GSH, the tetragonal mark shows addition of 1 mM of GSH, respectively.

As a result, the residual volume of the inorganic arsenic was maintained in a very low value in the food chain system of the kuruma prawn. On the other hand, an increase of the concentration of the trimethyl arsenic was also observed. That is, the residual volume of the inorganic arsenic which is generally thought as the harmful substance, is maintained in a very lower value(less or equal to 2%) than that of the comparative example(17.6%, see reference 1), and in particular, the inventors succeed in condensing the harmless trimethyl arsenic at more than 6.9(μ g As/g dry weight) of the concentration of trimethyl arsenic in the comparative example(reference 1) by adding the GSH.

### Reference Example

### In the Case of the Use of Only Artemia

An accumulation test was carried out under the condition described in the upper level of the following table 2 concerning 1 g of the marine-derived plankton, artemia(Artemia salina, Tetra Co., Ltd.). A breeding period of the artemia was for 1 day. The artemias were bred in a glass bath containing 2 L of an artificial seawater(Highpet) at 25° C., under the condition with the addition of 20 ppm of the arsenic trioxide. After breeding, the artemias were collected by the centrifugation.

After the accumulation test, the inorganic arsenic and organic arsenic existed in the organism concerning the artemia was examined. The content test of the inorganic arsenic and organic arsenic was carried out by using an arsenic analysis system for the various sort of the appearance(Shimadzu Corporation, atomic absorption spectro photometer AA-6800, pretreatment system ASA-2sp). The concentration was converted to a concentration of the dry weight using the same procedure described in the example 1. The result of this is shown in the lower level of the following table 2:

TABLE 2

| | No addition | | Both inorganic |
|---|---|---|---|
| | of inorganic | Addition of | arsenic and |
| | arsenic | inorganic arsenic | glutathione |
| iAs | — | 10 ppm | 10 ppm |
| Glutathione(GSH) | — | — | 10 ppm |
| iAs | 0.191 | 0.084 | 11.25 |
| MMA | 0 | 0 | 0 |
| DMA | 0 | 4.512 | 4.375 |
| TMA | 0 | 0 | 0 |

Units: a dry weight (μgAs/g dry)

The table 2 shows that in the case that the arsenic is directly imported into the artemia, it is impossible to convert the inorganic arsenic to the trimethyl arsenic (TMA).

According to the invention, a new method for treating arsenic using the food chain system comprising the phytoplankton—the zooplankton—the shellfish was provided. It became possible to carry out the treatment of the arsenic at high efficiency compared to the prior art and further to reduce the amount of the remnant inorganic arsenic, by carrying out the detoxification and the methylation of the arsenic according to the present invention using the above food chain system. The breeding of the shellfish under the existence of the the methylating accelerator factor may attain the further improvement of the efficiency for treating the arsenic. The preferable embodiment of the present invention has an advantageous effect that the use of the shellfish might separate the muscle from the shell, although it is possible to use the shellfish at the final step of the food chain system. Moreover, since the shrimp is a material which is easy to dry, it is possible to produce a totally-enclosed system of commercially and more effectively treating the arsenic.

1. A method for the detoxification of a hazardous compound according to the present invention, wherein the hazardous compound containing at least one element selected from the groups comprising arsenic, antimony and selenium is converted to a harmless substance produced by the food chain system.

2. A method for the detoxification of a hazardous compound according to claim 1, wherein the food chain system comprise a zooplankton.

3. A method for the detoxification of a hazardous compound according to claim 1, wherein the zooplankton is an artemia.

4. A method for the detoxification of a hazardous compound according to claim 1, wherein the detoxification is attained by reducing the percentage of the inorganic arsenic existing in the hazardous compound, using the food chain system.

5. A method for the detoxification of a hazardous compound according to claim 1, wherein the detoxification is attained by increasing the percentage of the organic arsenic existing in the hazardous compound, using the food chain system.

6. A method of treating the arsenic using the food chain according to claim 1, wherein the method comprises the steps of collecting and detoxificating the arsenic, and accumulating a detoxificated arsenic, and then storing the detoxificated arsenic.

7. A method of treating the arsenic according to claim 6, wherein the food chain system comprises phytoplankton—zooplankton—shellfish.

8. A method of treating the arsenic according to claim 7, wherein the shellfish is a shrimp class or a crab class capable of being farmed.

9. A method of treating the arsenic according to claim 8, wherein the shrimp class is a kuruma prawn(tiger prawn).

10. A method of treating the arsenic according to claim 7, wherein the phytoplankton is a chlorella, the zooplankton is an artemia, the shellfish is a greasyback shrimp.

11. A method of treating the arsenic according to claim 7, wherein the shellfish is bred under the existence of a methylating accelerator factor for the arsenic.

12. A method of treating the arsenic according to claim 7, wherein the artemia is bred under the existence of the methylating accelerator factor for the arsenic.

13. A method of treating the arsenic according to claim 12, wherein the methylating accelerator factor for the arsenic is a glutathione.

14. A method of treating the arsenic according to claim 7, wherein the concentration of the inorganic arsenic is reduced to less or equal to a concentration of an inorganic arsenic contained in a sea food of nature, and the inorganic arsenic is converted to a harmless organic arsenic.
